(19) United States
(12) Patent Application Publication
(10) Pub. No.: US 2008/0104109 A1
(43) Pub. Date: May 1, 2008

(54) Method, Apparatus and Media for Object Sharing

(75) Inventors: Scott Lenharth, Austin, TX (US); Vance Corn, Austin, TX (US); John Dodson, Pflugerville, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/555,668

(22) Filed: Nov. 1, 2006

(51) Int. Cl. G06F 17/00

(52) U.S. Cl. 707/103 R

(57) ABSTRACT

A computer-implemented method for instantiating an object of an object oriented model. The method may include receiving communication from a provider to instantiate the object. The method may also include determining if the provider is a first provider to instantiate the object If the provider is the first provider, the method may also include receiving communication whether the object is to be designated as a shared object or private object, and then designating the object as communicated by the provider.

### BACKGROUND

1. Technical Field

The present disclosure relates generally to information handling systems, and more particularly, to object sharing in a common information model (CIM) environment.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The complexity of managing information handling systems is increasing as the size, capabilities, and diversity of computer systems and networks increase. As a tool for managing information handling systems, the Common Information Model or “CIM” is a standard that defines how managed elements in an IT environment are represented as a common set of objects and relationships between them. There are a number of CIMs that are available, most notably those by the Distributed Management Task Force (DMTF), and the Storage Networking Industry Association (SNIA).

DMTF is a not-for-profit, vendor-neutral collaborative body, which is leading the development, adoption and unification of management standards and initiatives for desktop, enterprise and Internet environments. DMTF is chartered to adopt, create and maintain the specifications and technologies that provide management tools that deploy, discover and control management data in a standard way. DMTF's CIM standard is an object oriented management information model that unifies and extends existing management standards, such as for example, SNMP (Simple Network Management Protocol), DMI (Desktop Management Interface), and CMIP (Common Management Information Protocol).

SNIA is an association of producers and consumers of storage networking products, whose goal is to further develop storage networking technology and applications.

In CIM-based management a single provider can model and manage one or more hardware devices according to one or more CIM profiles. Different providers, implementing the same or different profiles, may each instantiate an object that represents the same physical device. Multiple objects representing a single device may have conflicting properties and may allow clients to invoke methods that the instrumentation is not prepared to serialize,

As a non-limiting example, an actual physical disk drive may be modeled in multiple CIM profiles: in a RAID controller profile by one provider, in a device enclosure profile by another provider, and in a diagnostic profile by another provider. The separate providers may be interested in managing this drive according to the specifics of their respective profile, which may cause a conflict. Currently, the CIM standards of DMTF and SNIA, and associated implemented CIM Object Managers (CIMOMs) do not solve this problem.

### SUMMARY

The following presents a general summary of some of the many possible embodiments of this disclosure in order to provide a basic understanding of this disclosure. This summary is not an extensive overview of at embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

According to one non-limiting embodiment there is provided a computer-implemented method for instantiating an object of an object oriented model. The method may include receiving communication from a provider to instantiate the object. The method may also include determining if the provider is a first provider to instantiate the object. The method may also include receiving communication whether the object is to be designated as a shared object or private object. The method may also include designating the object as communicated by the provider, if the provider is the first provider.

According to another non-limiting embodiment there is a computer-implemented method of reporting an assessed property value for a property of an object of an object oriented model. An array comprises reported property values with each reported property value corresponding to a different reporting provider implementing a different profile. The method may include receiving communication from a requester for the property value for the object. The method may also include determining if the property is a shared property. The method may also include providing at least one reported property value to the requestor, if the property is a shared property.

According to another embodiment there is provided a computer-implemented method of handling information relating to a shared object of an object oriented model. The method may include receiving information relating to a shared object from a first provider. The method may also include distributing the information to secondary providers as instructed by the first provider.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a schematic representation of a shared CIM class.

FIG. 2 is a schematic representation of one non-limiting method of the present disclosure.

### DETAILED DESCRIPTION

For purposes of this disclosure, an embodiment of an Information Handling System (IHS) may include any instrumentality or aggregate of instrumentalities operable to compute, classify, process, transmit, receive, retrieve, originate switch, store, display, manifest, detect, record, reproduce, handle, or utilize any form of information, intelligence or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic: ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

CIM is an information model, a conceptual view of the managed environment, which attempts to unify and extend the existing instrumentation and management standards using object-oriented constructs and design. CIM does not require any particular instrumentation or repository format. It is only an information model unifying the data, using an object-oriented format available from any number of sources.

Utilizing a hierarchical, object-oriented architecture, CIM may track and depict the complex interdependencies and associations among different managed objects. Such interdependencies may include those between logical network connections and underlying physical devices, or those of an e-commerce transaction and the web and database servers on which it depends,

At its very core, CIM is comprised of a specification and a schema. The CIM Specification defines the details for integration with other management models, while the CIM Schema provides the actual model descriptions. This schema defines how the managed elements in an IT environment are represented as a common set of objects and relationships between them. Thus, the CIM Schema captures concepts that are applicable to all common areas of management, independent of implementations.

The underlying CIM framework may be built upon through the use of CIM Extensions. These extensions are another part of the CIM Schema, and include platform-specific extensions of the CIM Schema. Extension schemas represent technology specific extensions of the common schema. Utilizing extensions, developers may expand from the basic model class and associations.

Extending the CIM or a proprietary schema may mean adding a property or method to an existing class/subclass of the CIM or a proprietary schema.

The present disclosure provides a number extensions to the existing CIM model, non-limiting examples of which include extensions which: (1) allow multiple providers to share an object instance that represents a hardware device; (2) allow a provider to claim, or arbitrate for, particular properties or methods of an object instance; (3) allow multiple providers to negotiate the health status of an object instance; and (4) allow multiple providers to coordinate events originating from the underlying hardware device.

It should be understood that the present invention provides new extensions to the existing CIM Model and various embodiments of this disclosure provide specific names for those new extensions. It should be further understood that the extension names utilized in the present disclosure were arbitrarily selected for this disclosure within the rules of the existing CIM Model. The present disclosure is not intended to be limited to any particular name for any particular extension. Rather, focus is to be directed to the function and operation of the extension, with the understanding that any name may be utilized. Thus, names selected for the new extensions are illustrative and are not intended to limit the scope of the specification and claims of the present disclosure.

As a new extension to the CIM model, the present invention provides the attributes “SHARED” and “PRIVATE.” These attributes may be applied to an object, and more to each of the object's properties and methods. As a non-limiting description the SHARED attribute indicates that the object, property or method to which it applies, may be shared by multiple providers for a single object. PRIVATE indicates that the first provider (the one that instantiates the object) has exclusive rights to the object, property or method.

According to the present disclosure, the system receives a request from a provider to instantiate an object and upon determination by the CIMON that the provider is the first provider and not a subsequent provider., communication is received from this first provider to designate the object as shared or private. The object is then so designated as communicated by the first provider. For those objects designated as shared, the first provider may then designate selected parts of the information about the object as shared or private. As a non-limiting example, for a shared object having 9 different properties, a provider may want to designate property nos. 1 4, 5, 7 and 9 as shared, and property nos. 2, 3, 6, and 8 as private. If the provider is not a first provider, the CIMOM rather than allowing a designation to be made, will make a determination of the shared properties or methods.

In CIM an “object” is a hardware or software system component that is represented as an instance of the CIM class. Data providers, event providers, and/or the CIM Object Manager (CIMOM), may provide information about objects.

The “ClMOM” is a component in the CIM Server that handles the interaction between management applications and providers. The CIMOM supports services such as event notification, remote access, and query processing.

As used herein, “instantiate” means producing a particular object from its class template. This generally involves allocation of a structure with the types specified by the template, and initialization of instance variables with either default values or those provided by the class's constructor function,

A “provider” communicates with managed objects to access data and event notifications from a variety of sources, such as the system registry or a Simple Network Management Protocol (SNMP) device, Providers forward this information to the CIM Object Manager for integration and interpretation.

As another new extension to the CIM model, the present invention provides the built-in method “AArbitrateShared( )” which is used by the CIMOM. Each provider may support this method. When the method ArbitrateShared( ) is invoked by the CIMOM for a particular property or method, the instantiating (first) provider must acknowledge the property as sharable or as exclusively owned (private). Subsequent providers are notified via this method that the private properties cannot be accessed or supported. In operation, if private, the CIMOM will not utilize the provider when supporting requests by clients for the property or method, and if shared, subsequent providers are notified via this method, including the namespace of the first provider.

As even another new extension to the CIM model the present invention provides two new attributes for assessed property values, that is, values that are reported by a provider concerning the object. The COMBINED property value is an array with one assessed value received from each provider of the shared property. This array may also contain provider and/or profile information corresponding to each reported value. In other embodiments of this disclosure, reported property values may be provided along with this corresponding provider and/or profile information. The LAST-REPORTED property value is the last reported by any provider.

As a non-limiting example, the health state for a drive may be “poor” from the perspective of the raid controller profile of a first provider, may be “healthy” from the perspective of the scoping enclosure profile of second provider, and may be “critical” from the perspective of a diagnostics profile of third provider. If treated as COMBINED, all of the values (“poor,” “healthy,” and “critical”) would be surfaced to clients. As discussed above, corresponding information regarding the profiles and/or providers may be provided. As a non-limiting example, it may be reported that the device health is “poor” as a raid controller, “healthy” as an enclosure, and “critical” as a diagnostic.

As yet another new extension to the CIM model, the present invention provides a CIMOM indication mechanism in which the first provider for a shared object, after issuing an indication, tells the CIMOM whether secondary providers may be notified that the indication was issued.

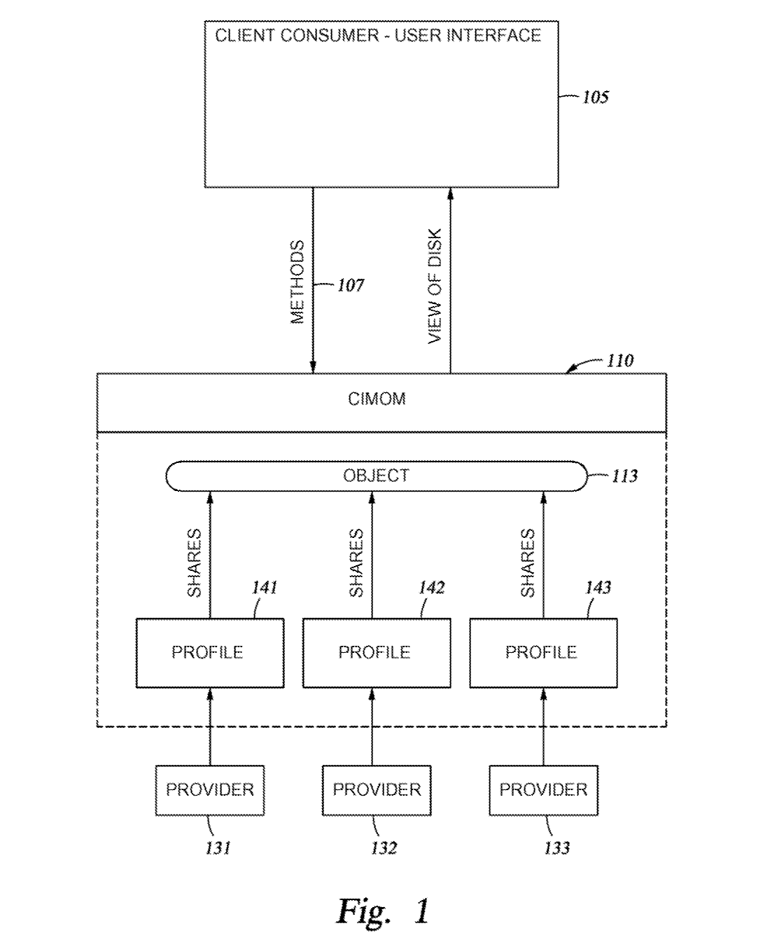

Referring now to FIG. 1 there is shown a shared CIM class 100. Client consumer user interface 105, allows operation of various methods 107, that is, functions included in a CIMOM 110 API interface to obtain information regarding object 113. In the practice of this disclosure, object 113 may be any hardware or software as desired. As a non-limiting example, object 113 is a disk drive.

As shown, provider 131 registered profile 141 with CIMOM 110, provider 132 registered profile 142 with CIMOM 110, and provider 133 registered profile 143 with CIMOM 110. The various providers 131, 132, and 133 may share object 113, which In a non-limiting example is a disk drive. In non-limiting examples of the profiles, profile 141 is a raid controller profile, profile 142 is an enclosure profile, and profile 143 is a diagnostic profile.

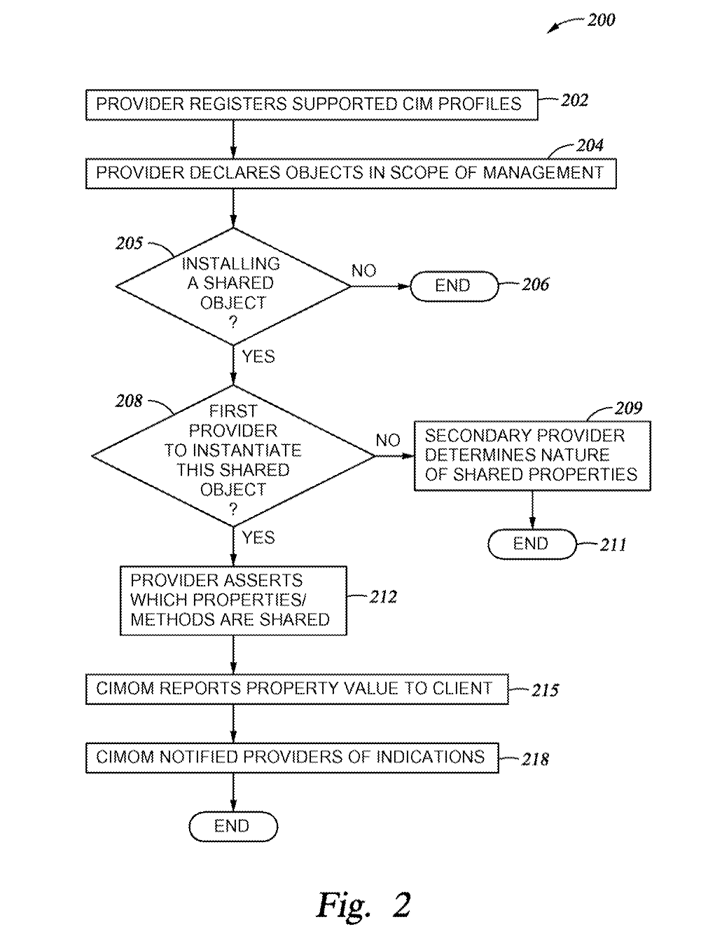

Referring now to FIG. 2 there is shown a schematic representation of method 200, one non-limiting embodiment of the methods of the present disclosure for instantiating a shared object,

Method 200 may include one or more of the following steps to instantiate a shared object In the following method, communications made by providers may also be considered as being received by the system, more specifically received by the CIMOM. In 202 the provider communicates registration of supported profiles. Making reference to FIG. 1, for the object 113, providers 141, 142 and 143 may at various times register respective supported profiles 131, 132 and 133.

Next, in 204 the provider may communicate that an object is within the scope of management (i.e. the profile). Again making reference to FIG. 1, providers 141, 142 and 143 may at various times declare object 113 within the scope of management.

In 205 a determination is made as to whether the provider is instantiating a shared object. If the object instantiated is private, then in 206 the inquiry is ended. If the object is to be shared, the system determines if the provider is the first provider. One of ordinary skill in the art may utilize any method or means to determine if the provider is the first provider. In the embodiment as shown, in 208 the CIMOM will utilize durable/concrete object properties to determine if the object was previously instantiated in any namespace of the CIMOM. The format of the durable/concrete object properties is separately standardized according to hardware device. If this is the first instantiation of the object, that is, if the provider is the first provider, then in 212 the first instantiating provider asserts which properties and methods are shared. If previously instantiated, that is, the provider is not the first provider, then in 209 this subsequent instantiating provider determines the nature of the shared properties or the nature is communicated to this provider by the CIMOM.

Making reference to FIG. 1, assuming that provider 131 is the first substantiating provider then it communicates which properties and methods are shared, and whether other providers may/may not be told that the property/method was invoked. Subsequent providers 132 and 133 would then determine the nature of the shared properties.

In 215 for shared properties, using device health as a non-limiting example, the CIMOM reports property value to the client 105, and in 218 the CIMOM notifies providers of the indications.

For shared methods, CIMOM invokes the first provider with the parameters, and then determines whether secondary providers are provided with the results according to the results of ArbitrateShared( ) from the first provider.

For a shared indication, CIMOM notifies secondary provider(s) about the event. Each provider chooses whether to send a duplicate indication, if allowed.

In embodiments, part or all of the methods described herein may be described as instructions for an information handling system, and stored on one or more computer readable media or transmitted by a propagated signal. In other non-limiting embodiments information handling systems are disclosed which are configured to carry out one or more of the methods described herein, generally by having instructions for the methods stored thereon.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

What is claimed is:

1. A computer-implemented method for instantiating an object of an object oriented model, the method comprising:
receiving communication from a provider to instantiate the object;
determining if the provider is a first provider to instantiate the object;
receiving communication regarding designating the object as a shared object or private object; and
designating the object as communicated by the provider, if the provider is the first provider.

2. The method of claim 1 wherein the object comprises information selected from the group consisting of property and methods, and wherein the step of designating the object includes designating whether each property or method is to be a shared or exclusive to the provider.

3. The method of claim 1 further comprising,
determining nature of shared properties or methods, if the provider is not a first provider.

4. The method of claim 1, wherein the object oriented model is a common information model (CIM).

5. The method of claim 4, wherein the steps of the method are executed by a CIM Object Manager (CIMOM).

6. A computer-implemented method of reporting an assessed property value for a property of an object of an object oriented model, wherein an array comprises reported property values with each reported property value corresponding to a different reporting provider implementing a different profile the method comprising:
receiving communication from a requester for the property value for the object;
determining if the property is a shared property; and
providing at least one reported property value to the requestor, if the property is a shared property.

7. The method of claim 6, wherein the step of providing comprises providing all of the reported property values to the requester.

8. The method of claim 6, wherein the array of reported property values comprises a last reported property value, and wherein the step of providing comprises providing the last reported property value to the requestor.

9. The method of claim 6, wherein for each reported property data in the array the array further comprises corresponding profile or provider information, wherein the step of providing comprises providing all of the reported property values and corresponding profile or provider information.

10. The method of claim 6, further comprising,
reporting that the property is not available, if the property is a private property.

11. The method of claim 6, wherein the object oriented model is a common information model (CIM).

12. The method of claim 11, wherein the steps of the method are executed by a CIM Object Manager (CIMOM).

13. A computer-implemented method of handling information relating to a shared object of an object oriented model, the method comprising:
receiving information relating to a shared object from a first provider; and
distributing the information to secondary providers as instructed by the first provider.

14. The method of claim 13, wherein the information comprises an assessed property value for the object.

15. The method of claim 13, wherein the information comprises an indication about the object.

16. The method of claim 13, wherein the information comprises results of a method relating to the object.

17. The method of claim 13, wherein the object oriented model is a common information model (CIM).

18. The method of claim 17, wherein the steps of the method are executed by a CIM Object Manager (CIMOM).
